(19) United States
(12) Patent Application Publication
(10) Pub. No.: US 2021/0211343 A1
(43) Pub. Date: Jul. 8, 2021

(54) NUMEROLOGY-DEPENDENT PHYSICAL UPLINK CONTROL CHANGNEL. STRUCTURE WIRELESS COMMUNICATION

(71) Applicant: Telefonaktiebolaget LM Ericsson (publ), Stockholm (SE)

(72) Inventors: Robert BALDEMAIR, SOLNA (SE); Erik DAHLMAN, STOCKHLM (SE); Sorour FALAHATI, STOCKHLM (SE); Daniel LARSSON, LUND (SE); Stefan PARKVALL, BROMMA (SE)

(21) Appl. No.: 16/075,335

(22) PCT Filed: May 4, 2018
(86) PCT No.: PCT/SE2018/050469

§ 371 Date: Aug. 3, 2018

Related U.S. Application Data
(60) Provisional application No. 62/501,799, filed on May 5, 2017.

(51) Int. Cl. H04L 27/26; H04W 72/04; H04W 72/12

(52) U.S. Cl. CPC H04L 27/26025; H04W 72/0413; H04W 72/1263; H04W 72/0453; H04W 72/0446

(57) ABSTRACT

The present disclosure relates to control information signalling in mobile communications, to uplink control information signalling and physical uplink control channels in wireless communications. The proposed technique relates to methods transmitting a physical uplink control channel, and for adapting, selecting, or determining uplink control channel structures depending on the numerology used for the physical uplink control channel transmissions. The disclosure also relates to corresponding devices and to a computer program for executing the proposed methods, and to a carrier containing said computer program. The disclosure proposes a method, for use in a wireless device, for transmitting a physical uplink control channel comprising transmitting uplink control information, UCI, to one or more radio nodes on a physical uplink control channel having a physical uplink control channel structure being based on at least one numerology configured for or used by the wireless device for transmitting the physical uplink control channel.

### TECHNICAL FIELD

The present disclosure relates to uplink control information signalling and physical uplink control channels in wireless communications. More specifically, the proposed technique relates to methods transmitting a physical uplink control channel, and for adapting, selecting, or determining uplink control channel structures depending on the numerology used for the physical uplink control channel transmissions. The disclosure also relates to corresponding devices and to a computer program for executing the proposed methods, and to a carrier containing said computer program.

### BACKGROUND

The fifth generation of mobile telecommunications and wireless technology is not yet fully defined but in an advanced draft stage within 3GPP. 5G wireless access will be realized by the evolution of Long Term Evolution, LTE, for existing spectrum in combination with new radio access technologies that primarily target new spectrum. Due to the scarcity of available spectrum, spectrum located in very high frequency ranges (compared to the frequencies that have so far been used for wireless communication), such as 10 GHz and above, are planned to be utilized for future mobile communication systems. Thus, evolving to 5G includes work on a New Radio (NR) Access Technology (RAT), also, besides New Radio (NR), known as 5G or next generation (NX). The NR air interface targets spectrum in the range from sub-1 GHz (below 1 GHz) up to 100 GHz with initial deployments mainly expected in frequency bands not utilized by LTE. Some LTE terminology is used in this disclosure in a forward looking sense, to include equivalent 5G entities or functionalities although a different term may be specified in 5G. A general description of the agreements on 5G New Radio (NR) Access Technology so far is contained in 3GPP TR 38.802 V14.0.0 (2017-03). Final specifications may be published inter alia in the future 3GPP TS 38.2** series.

Physical resources for RATs used in wireless communication, such as LTE and NR, networks may be scheduled in time and frequency in what could be seen as a time and frequency grid. For example, the basic downlink physical resource of the RAT LTE can be seen as a time-frequency grid as illustrated in FIG. 1. LTE uses Orthogonal Frequency Division Multiplexing (OFDM) in the downlink (DL) and a pre-coded version of OFDM called Single Carrier Frequency Division Multiple Access (SC-FDMA) in the uplink (UL). LTE uses OFDM to transmit the data over many narrow band carriers, usually of 180 KHz each, instead of spreading one signal over the complete 5 MHz carrier bandwidth, in other words OFDM uses a large number of narrow subcarriers for multi-carrier transmission to carry data. OFDM is thus a so called multi carrier system. Multi carrier systems are systems that uses multiple sinusoidal waves of predefined frequencies as multiple subcarriers. In multicarrier systems, data are divided on the different subcarriers of one transmitter. The difference between the frequencies of two adjacent subcarriers is called the frequency domain subcarrier spacing or subcarrier spacing for short. The OFDM symbols are grouped into so called physical resource blocks (PRB) or just resource blocks (RB). The basic unit of transmission in LTE is a RB, which in its most common configuration consists of 12 subcarriers and 7 OFDM symbols (one slot). In LTE the resource blocks have a total size of 180 kHz in the frequency domain and 0.5 ms (one slot) in the time domain. Each element in the time-frequency grid containing one symbol and one subcarrier is referred to as a resource element (RE). Each 1 ms Transmission Time Interval (TTI) consists of two slots (Tslot), usually represented by 14 OFDM symbols. LTE downlink transmissions are organized into radio frames of 10 ms, each radio frame consisting of ten equally-sized subframes of length Tsubframe=1 ms, as shown in FIG. 2. The number of samples in one frame (10 ms) is 307200 (307.200 K) samples. This means that the number of samples per second is 307200×100=30.72 M samples. The resource allocation in LTE is typically described in terms of resource blocks, where a resource block corresponds to one slot (0.5 ms) in the time domain and 12 contiguous subcarriers in the frequency domain. Resource blocks are numbered in the frequency domain, starting with 0 from one end of the system bandwidth.

The new RAT NR will use a similar structure for the physical resources as LTE, using multiple carriers in frequency and symbols in the time domain, defining resource elements of physical resource blocks. The physical resource parameters may vary in NR. For example, the carriers may span a variable frequency range, the frequency spacing or density between the carriers may vary, as well as the cyclic prefix (CP) used. The frequency spacing between subcarriers can be seen as the frequency bandwidth between the center of a subcarrier and the adjacent subcarrier, or the bandwidth occupied by each subcarrier in the frequency band. Resource defined by one subcarrier and one symbol is called as resource element (RE). Sampling time can be defined differently depending on subcarrier spacing (numerology) and in most case two types of Timing Unit Tc and Ts are used, Tc=0.509 ns and Ts=32.552 ns.

A numerology defines basic physical layer parameters, such as subframe structure and may include transmission bandwidth, subframe duration, frame duration, slot duration, symbol duration, subcarrier spacing, sampling frequency, number of subcarrier, RB per subframe, symbols per subframe, CP length etc. In LTE the term numerology includes, e.g., the following elements: frame duration, subframe or TTI duration, slot duration, subcarrier spacing, cyclic prefix length, number of subcarriers per RB, number of RBs within the bandwidth (different numerologies may result in different numbers of RBs within the same bandwidth). The exact values for the numerology elements in different RATs are typically driven by performance targets. For example, performance requirements impose constraints on usable subcarrier spacing sizes, e.g. the maximum acceptable phase noise sets the minimum subcarrier bandwidth while the slow decay of the spectrum (impacting filtering complexity and guardband sizes) favors smaller subcarrier bandwidth for a given carrier frequency, and the required cyclic prefix sets the maximum subcarrier bandwidth for a given carrier frequency to keep overhead low. However, the numerology used so far in the existing RATs is rather static and typically can be trivially derived by the user equipment (UE) or wireless device, e.g., by one-to-one mapping to RAT, frequency band, service type (e.g., Multimedia Broadcast Multicast Service (MBMS)), etc. In LTE downlink which is OFDM-based, the subcarrier spacing is 15 kHz for normal CP and 15 kHz and 7.5 kHz (i.e., the reduced carrier spacing) for extended CP, where the latter is allowed only for MBMS-dedicated carriers.

The support of multiple numerologies has been agreed for NR, which numerologies can be multiplexed in the frequency and/or time domain for the same or different UEs. Different numerologies may thus coexist on the same subcarrier. A numerology in NR may be defined by subcarrier spacing and CP overhead. Multiple subcarrier spacings can be derived by scaling a basic subcarrier spacing by an integer N. The numerology used can be selected independently of the frequency band although it is assumed not to use a very low subcarrier spacing at very high carrier frequencies. Flexible network and UE channel bandwidth is supported. A table showing different numerologies proposed for NR is shown in FIG. 3. In NR which is to be based on OFDM, the multiple numerologies will be supported for general operation. A scaling approach (based on a scaling factor 2\hat{ }n, n∈N_0) is considered for deriving subcarrier spacing candidates for NR. Values for subcarrier bandwidths currently discussed include among others 3.75 kHz, 15 kHz, 30 kHz, 60 kHz. The numerology-specific slot durations can then be determined in ms based on the subcarrier spacing: subcarrier spacing of (2\hat{ }m*15) kHz, m being an integer, gives exactly 1/2 m 0.5 ms for a slot that is 0.5 ms in the 15 kHz numerology. Thus, each numerology is related to an n value, and where n is a non-negative integer, the subcarrier spacing is defined as 15 kHz*2⁴ for a numerology n. Each symbol length (including CP) of 15 kHz subcarrier spacing equals the sum of the corresponding 2n symbols of the scaled subcarrier spacing.

It has been proposed that the duration of the subframes in NR should always have a duration of 1 ms, and that the transmission could be flexibly defined by using slots, the slots being proposed to contain 14 time symbols (symbols of a defined time duration), such as OFDM (DFTS-OFDM, Discrete Fourier Transform Spread OFDMA) or SC-FDMA (also referred to as type A scheduling). The use of so called “mini-slots” (or type B scheduling) have also been proposed which could have a variable length (any duration of symbols) and start position, thus they could be located anywhere in the slots, and could be as short as one symbol long. In a Type A transmission the demodulation reference signals, DM-RS, are defined with respect to slot boundaries. A Type A transmission starts in the first or first few symbols of a slot and does not necessarily extend to the end of a slot. For Type B the DM-RS are relative to the start of the physical shared channels. The can be flexible placed in a slot. In NR the transmission bandwidth of a single carrier transmitted by a network node (also known as gNB) may be larger than the UE bandwidth capability, or the configured receiver bandwidth of a connected device (such as UE). Each gNB may also transmit using different numerologies which are time division multiplexed (TDM) or frequency division multiplexed (FDM).

Subcarrier spacings of at least up to 480 kHz are currently being discussed for NR (the highest discussed values correspond to millimeter-wave based technologies). It has also been agreed that multiplexing different numerologies within a same NR carrier bandwidth is supported, and FDM and/or TDM multiplexing can be considered. It has further been agreed that multiple frequency/time portions using different numerologies share a synchronization signal, where the synchronization signal refers to the signal itself and the time-frequency resource used to transmit the synchronization signal. Yet another agreement is that the numerology used can be selected independently of the frequency band although it is assumed that a very low subcarrier spacing will not be used at very high carrier frequencies.

In NR the transmission bandwidth of a single carrier transmitted by a network node (also known as gNB) may be larger than the UE bandwidth capability, or the configured receiver bandwidth of a connected device (such as UE). Each gNB may also transmit using different numerologies which are time division multiplexed (TDM) or frequency division multiplexed (FDM). Thus, several numerologies will be used below 6 GHz, which give rise to new problems of achieving equivalent coverage for all numerologies.

### SUMMARY

An object of the present disclosure is to provide methods and devices which seek to mitigate, alleviate, or eliminate the above-identified deficiencies in the art and disadvantages singly or in any combination. This object is obtained by a method for use in a wireless device in a wireless communication system, for transmitting a physical uplink control channel, the method comprising transmitting uplink control information to one or more radio nodes on a physical uplink control channel having a physical uplink control channel structure, the physical uplink control channel structure used being based on at least one numerology or frequency subcarrier spacing configured for or used by the wireless device for transmitting the physical uplink control channel.

According to some aspects, the method further comprises obtaining information indicating at least one numerology or frequency subcarrier spacing configuration to be used by the wireless device and determining a physical uplink control channel structure, the physical uplink control channel structure being determined based on at least one numerology or frequency subcarrier spacing configured for or used by the wireless device.

According to some aspects, the disclosure proposes a method for use in a network node in a wireless communication system for receiving a physical uplink control channel, the method comprising transmitting information indicating at least one physical uplink control channel numerology or frequency subcarrier spacing configuration to at least one wireless device, and receiving, from the at least one of the wireless device, an uplink control information message on a physical uplink control channel, the physical uplink control channel structure being based on the transmitted information.

According to some aspects, the method further comprises obtaining information indicating one or more of numerologies or frequency subcarrier spacings that the wireless device is able to use and/or that the wireless device should use and transmitting a message to the one or more wireless devices comprising information indicating a mapping between the numerology or frequency subcarrier spacing to a physical uplink control channel structure.

According to some aspects, the disclosure proposes a wireless device, configured to operate in a wireless communication system, configured for transmitting a physical uplink control channel to a network node, the wireless device comprising a communication interface and processing circuitry configured to cause the wireless device to transmit uplink control information to one or more radio nodes on a physical uplink control channel having a physical uplink control channel structure, the physical uplink control channel structure used being based on at least one numerology or frequency subcarrier spacing used by the wireless device for transmitting the physical uplink control channel.

According to some aspects, the disclosure proposes a network node, configured to operate in a wireless communication system, configured for receiving a physical uplink control channel from a wireless device, the network node comprising a communication interface, and processing circuitry configured to cause the network node to transmit information indicating at least one numerology or frequency subcarrier spacing to one or more wireless devices, to receive an uplink control information message on a physical uplink control channel, the structure of the physical uplink control channel being based on the transmitted information.

According to some aspects, the disclosure proposes a computer program comprising computer program code which, when executed in a wireless device, causes the wireless device to execute the methods described below and above.

According to some aspects, the disclosure proposes a computer program comprising computer program code which, when executed in a network node, causes the network node to execute the methods described below and above.

According to some aspects, the disclosure proposes a carrier containing the computer program, wherein the carrier is one of an electronic signal, optical signal, radio signal, or computer readable storage medium.

### BRIEF DESCRIPTION OF THE DRAWINGS

FIG. 1 illustrates the LTE downlink physical resource seen as a time/frequency grid.

FIG. 2 is an illustration of the LTE time-domain structure.

FIG. 3 is a table showing different numerologies proposed for NR.

FIG. 4 is a table showing an overview of some LTE PUCCH formats and the UCI information they may carry.

FIG. 5 is a table showing PUCCH lengths in number of symbols for different numerologies (different subcarrier spacings of different numerologies) and for different Long PUCCH configurations, “long Long PUCCH” and “short Long PUCCH” configurations (Conf 1/Conf2).

FIG. 6 is a flowchart of an exemplary process for transmitting a physical uplink control channel.

FIG. 7 is a flowchart of an exemplary process for receiving a physical uplink control channel.

FIG. 8 is a block diagram illustrating a wireless device configured to transmit a physical uplink control channel.

FIG. 9 is a block diagram illustrating a network node configured to receive a physical uplink control channel.

FIG. 10 is an alternative block diagram of a wireless device configured to transmit a physical uplink control channel.

FIG. 11 is an alternative block diagram illustrating a network node configured to receive a physical uplink control channel.

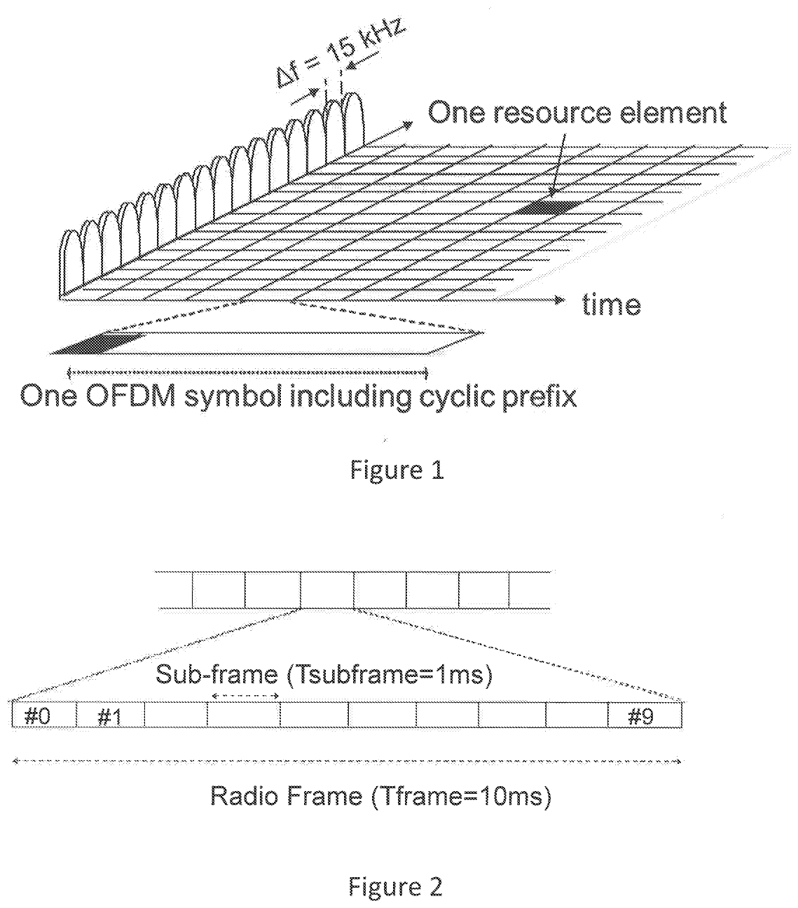

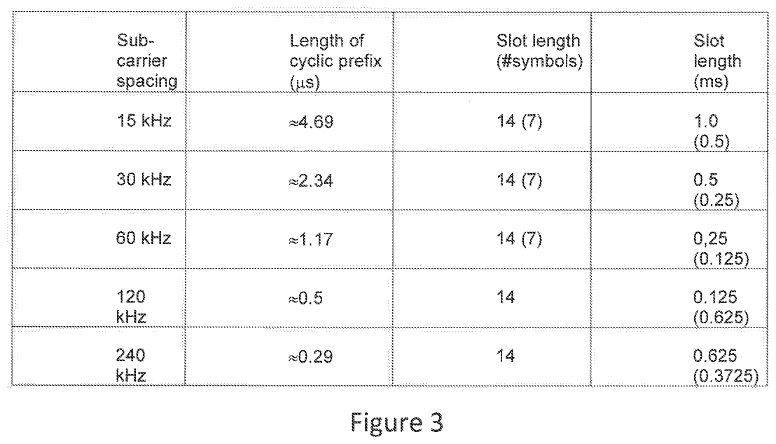

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some embodiments a non-limiting term “UE” is used. The UE herein can be any type of wireless device capable of communicating with network node or another UE over radio signals. The UE may also be radio communication device, target device, device to device (D2D) UE, machine type UE or UE capable of machine to machine communication (M2M), a sensor equipped with UE, IPad, Tablet, mobile terminals, smart phone, laptop embedded equipped (LEE), laptop mounted equipment (LME), USB dongles, Customer Premises Equipment (CPE) etc. Also in some embodiments generic terminology “network node”, is used. It can be any kind of network node which may comprise of a radio network node such as base station, radio base station, base transceiver station, base station controller, network controller, gNB, NR BS, evolved Node B (eNB), Node B, Multi-cell/multicast Coordination Entity (MCE), relay node, access point, radio access point, Remote Radio Unit (RRU) Remote Radio Head (RRH), a multi-standard BS (a.k.a. MSR BS), TP (transmission point), TRP (transmission reception point), a core network node (e.g., MME, SON node, a coordinating node, positioning node, MDT node, etc.), or even an external node (e.g., 3rd party node, a node external to the current network), etc. The network node may also comprise a test equipment.

The term “symbol” or “time symbol” defines a duration in the time domain. A symbol or time symbol may be a OFDM, DFTS-OFDM or SC-FDMA symbol.

In wireless RATs data and control information may be transmitted using different physical channels. In LTE for example, several physical channels exist on the downlink and uplink, such as the physical downlink shared channel (PDSCH) for transmitting user data and control information, the physical downlink control channel (PDCCH) for transmitting control messages, the physical uplink shared channel (PUSCH) for transmitting user data and control information and the physical uplink control channel (PUCCH) for transmitting control messages. Similar channels will exist in NR, even though their structure and maybe also their name may differ from the ones used in LTE. The PUCCH in LTE is used to carry uplink control information (UCI). UCI may also be transported on PUSCH if a PUSCH transmission is scheduled, i.e. if the UE has been assigned an uplink resource for data transmission (UE has application data or radio resource control, RRC, signaling). An LTE UE doesn't normally transmit both PUCCH and PUSCH during the same subframe. Even though Rel-10 defines simultaneous transmission of PUSCH and PUCCH, is hardly ever used. LTE PUCCH is a stand-alone uplink physical channel and comprises HARQ (Hybrid Automatic Repeat Request) ACK/NACK (NAK) (Acknowledgement/Negative Acknowledgement), CQ-channel quality indicators, MIMO (Multiple-input Multiple-Output) feedback—RI (Rank Indicator), PMI (Precoding Matrix Indicator), scheduling requests for uplink transmission, BPSK or QPSK used for PUCCH modulation. PUCCH may be allocated RBs at the edge of channel BW to avoid fragmenting RBs available to PUSCH.

A scheduling request (SR) is a physical layer message from the UE/wireless device to the network node/base station asking the network for an UL grant to transmit e.g. data on PUSCH. The UL grant may be sent in a downlink control information (DCI) message, e.g. DCI 0-0 or 0-1. The UE may transmit the SR on in PUCCH or PUSCH in e.g. UCI or as buffer status report. Not all PUCCH format can carry the SR. The UE is using a certain PUCCH format depending on situation. In LTE the eNB needs to configure the UE with SR configuration via RRC signalling in order for the UE to be able to transmit SR on PUCCH. Once SR is triggered, the UE calculates the SR periodicity and offset. After transmitting the first SR on PUCCH, if the UE doesn't receive uplink resources from the eNB, the UE may re-send SR on PUCCH at a later time. The scheduling request configuration in LTE is specified in Table 10.1.5-1 of 3GPP TS 36.213, also indicating the SR periodicity. In NR SR configuration periodicities can be very flexible configured and include among others 2 symbols, 7 symbols, 1, 2, 5 and 10 ms. The periodicity of the SR will be dependent on the numerology used, such as 15 or 30 kHz in the “low bands” (below 6 GHz) and 60 or 120 kHz in the “high bands” (above 6 GHz).

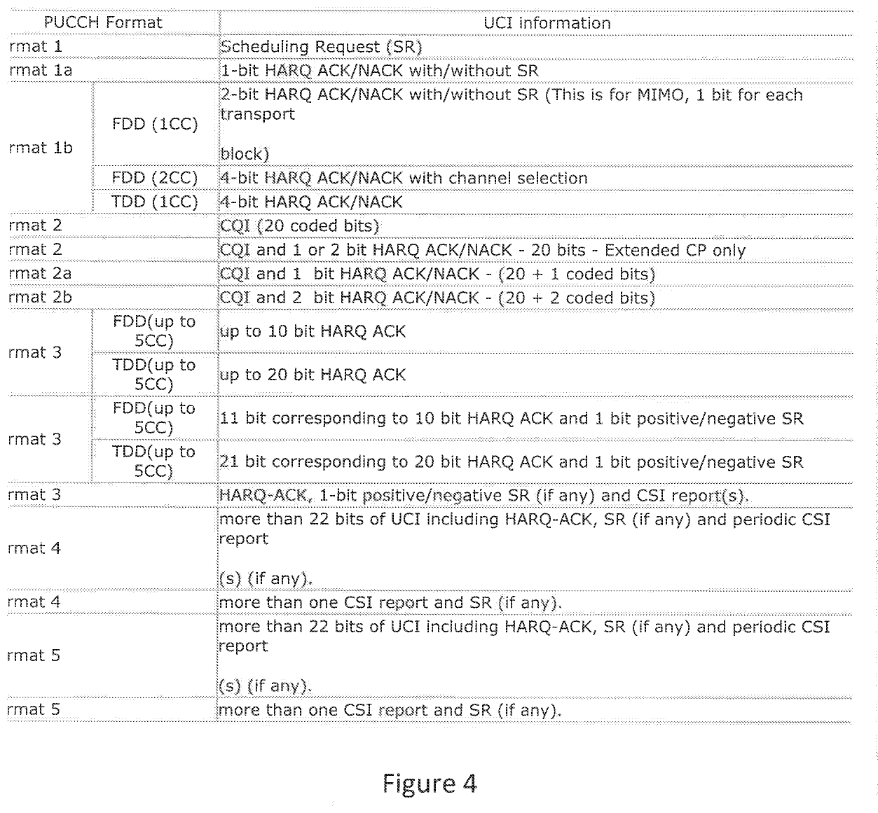

The standard specifies several LTE PUCCH formats to be used for different situations. FIG. 4 is a table from the 3GPP specification 36.213 and shows an overview of some LTE PUCCH formats and the UCI information they may carry. In addition to the timing the UE also needs to know the exact PUCCH resource. In LTE—depending on PUCCH format—implicit and explicit signaling is used. For PUCCH Format 1a/1b and 2/2a/2b implicit signaling is used where the PUCCH resource is derived from the position of the scheduling PDCCH CCE (in addition to RRC configured parameters). For other PUCCH formats a pool of PUCCH resources is configure and an ACK/NACK Resource Indicator (ARI) is used to dynamically select one of the configured resources.

ITE defines a multitude of different PUCCH formats, covering a large range of payloads:

PUCCH Format 1/1a/1b

Used for scheduling request and one or two-bit HARQ feedback. This format uses sequence modulation where a low-PAPR base sequence is mapped onto 12 subcarriers of one OFDM symbol and time-domain block-spreading. Different users can be multiplexed onto the same time-frequency resource by assigning different users different cyclic shifts of the same base-sequence and/or assigning different block-spreading sequences. The allocated 12 subcarriers frequency-hop at slot boundary to obtain frequency-diversity. Three out of seven symbols are used for reference signal (normal cyclic prefix).

PUCCH Format 2/2a/2b

Used for CQI up to 13 bits and also for CQI together with HARQ feedback. The payload is encoded using Reed Muller coding and pairs of bits are mapped to QPSK symbols. Each QPSK symbol is multiplied with a low-PAPR base sequence which is mapped onto 12 subcarriers of one OFDM symbol. Different coded bits are transmitted using different OFDM symbols and the allocated 12 subcarriers frequency-hop at slot boundary to obtain frequency-diversity. In total coded bits are mapped across 20 OFDM symbols. Format 2a/2b which carry in addition to CQI also HARQ feedback modulates the second reference signal with one- or two-bit HARQ feedback. Multiple users can be multiplexed onto the same time-frequency resource by assigning different users different cyclic shifts of the same base-sequence. Two out of seven symbols are used for reference signal (normal cyclic prefix).

PUCCH Format 3

PUCCH Format 3 is for payloads up to 11 or 22 bits. The payload is encoded using Reed Muller coding (up to 11 bits: single Reed Muller code, up to 22 bits: dual Reed Muller code) generating in both cases 48 coded bits (in case of single Reed Muller code the bits are repeated). The 48 coded bits are mapped to 24 QPSK symbols; 12 QPSK symbols are transmitted on 12 subcarriers in the first slot and the other 12 QPSK symbols on other 12 subcarriers (frequency-hopped to obtain frequency-diversity) in the second slot. In each slot, the 12 QPSK symbols are DFT-precoded to obtain low PAPR and transmitted on 12 subcarriers, and repeated (with block-spreading) across OFDM symbols. Multiple users can be multiplexed onto the same time-frequency resource by assigning different users different block-spreading sequences. Two out of seven symbols are used for reference signal (normal cyclic prefix).

PUCCH Format 4

PUCCH format 4 is for payloads up to 768 bits (assuming 8 allocated PRBs and code rate 1/3). The payload is encoded using tail-biting convolution codes and mapped to QPSK modulation symbols. The modulation symbols are portioned into groups and each group Is DFT-precoded and transmitted in a separate OFDM symbol. The allocated number of PRB can be adjusted to the payload size. The allocated PRBs frequency-hop at slot boundary to obtain frequency-diversity. Per slot one DM-RS symbol is inserted, i.e. one out of seven symbols is used for reference signal (normal cyclic prefix). This format does not support multiplexing of different users onto the same resource.

PUCCH Format 5

This format is very similar to PUCCH Format 4 and supports payload sizes up to 48 bits (code rate 1/3). Different from PUCCH Format 4 this format only supports a fixed PRB allocation of one PRB and allows multiplexing of two users onto the same time-frequency resource. This multiplexing is achieved by block-spreading six QPSK symbols with a length-two sequence (resulting in 12 modulation symbols) that are input to the DFT precoder.

The physical uplink control channel for NR, which is sometimes denoted PUCCH in this disclosure even though a different name may also be possible, will also make use of several physical uplink control channel formats, or so called PUCCH formats. LTE defines a multitude of PUCCH formats with sometimes rather similar payload sizes. It is preferable to reduce the number of PUCCH formats in NR, and PUCCH schemes have been proposed which covers a wide range of payloads and also enables multiplexing of users onto the same time-frequency resource. This format together with another format for small payload sizes can cover all required UCI payload sizes of NR resulting in much fewer PUCCH formats than in LTE.

NR defines different slot formats or slot configurations, a slot can be for example 14 symbols which is also referred to as a slot interval, a slot duration can be a pure UL slot or it can have a DL control region, a slot duration can accommodate differently long guard periods between duplex directions, multiple slots can be aggregated, numerologies with extended cyclic prefix result in fewer symbols per slot. For example, a slot configuration comprising an extended cyclic prefix might contain 12 symbols in a slot, while a slot with a normal cyclic prefix contains 14 symbols. Further, one may have different slot configurations for different numerologies, then every 7th (15 kHz) or 14th (30 kHz) symbol has a slightly larger CP, which may be referred to as a “special symbol”, such as with a SCS of 15 kHz a slot configuration of 14 symbols may comprise 1 special symbol followed by 6 normal symbols followed by 1 special symbol followed by 6 normal symbols, while with a SCS of 30 kHz a slot configuration of 14 symbols may be one special symbol followed by 13 normal symbols. This slightly longer CP is different from the extended CP. The slot configuration may define the number of normal and special symbols, and the structure (e.g. length) of the physical uplink control channel comprise also the special symbol.

A “slot” could also refer to the length in symbols of a transmission. All these factors impact the number of OFDM symbols that are available for PUCCH transmission. To avoid defining PUCCH formats for each length the proposed design does not use block-spreading across OFDM symbols to multiplex users. It is also preferable to have a single PUCCH format which payload size covers a large range. To enable this the proposed scheme can use different QAM modulation orders (even though preferred is a single modulation order, QPSK) or more assigned resources in frequency-domain.

It has been agreed in NR to be able to configure only parts of the available carrier bandwidth using a construction called a bandwidth part (BWP). Typically, one or more such bandwidth parts could be configured to a UE, wherein only one is active, and the UE may then switch between these bandwidth parts, i.e. change which one is the active one. This is especially useful for devices that are not capable of handling the whole bandwidth of the carrier (limited capability devices). There could be an initial and/or default BWP, and the activation could be time based, switching back to the initial or default when the timed has timed out. For a UE, a configured DL (or UL) BWP may overlap in frequency domain with another configured DL (or UL) BWP in a serving cell. For each serving cell, the maximal number of DL/UL BWP configurations is: for paired spectrum: 4 DL BWPs and 4 UL BWPs, for unpaired spectrum: 4 DL/UL BWP pairs, and for supplementary uplink, SUL: 4 UL BWPs. For paired spectrum, support a dedicated timer for timer-based active DL BWP switching to the default DL BWP. A UE starts the timer when it switches its active DL BWP to a DL BWP other than the default DL BWP. A UE restarts the timer to the initial value when it successfully decodes a DCI to schedule physical downlink shared channel(s), PDSCH(s), in its active DL BWP. A UE switches its active DL BWP to the default DL BWP when the timer expires. Each bandwidth part is associated with a specific numerology (sub-carrier spacing, CP type). A UE expects at least one DL bandwidth part and one UL bandwidth part being active among the set of configured bandwidth parts for a given time instant. A UE is only assumed to receive/transmit within active DL/UL bandwidth part(s) using the associated numerology, at least for PDSCH and/or PDCCH for DL and PUCCH (physical uplink control channel) and/or PUSCH (physical uplink shared channel) for UL. It is currently under discussion if multiple bandwidth parts with same or different numerologies can be active for a UE simultaneously, but has been agreed that in Release 15 of NR in 3GPP only one shall be active at a time. It does not imply that it is required for UE to support different numerologies at the same instance. The active DL/UL bandwidth part is not assumed to span a frequency range larger than the DL/UL bandwidth capability of the UE in a component carrier. It has been agreed to specify necessary mechanism to enable UE RF retuning for bandwidth part switching. In case of one active DL BWP for a given time instant, the configuration of a DL bandwidth part includes at least one CORESET (Control-resource set), a CORESET consisting of multiples resource blocks (i.e. multiples of 12 REs) in frequency domain and ‘1 or 2 or 3’ OFDM symbols in time domain. A UE can assume that PDSCH and corresponding PDCCH (PDCCH carrying scheduling assignment for the PDSCH) are transmitted within the same BWP if PDSCH transmission starts no later than K symbols after the end of the PDCCH transmission. In case of PDSCH transmission starting more than K symbols after the end of the corresponding PDCCH, PDCCH and PDSCH may be transmitted in different BWPs. For the indication of active DL/UL bandwidth part(s) to a UE, the following options are considered (including combinations thereof): Option #1: DCI (explicitly and/or implicitly), Option #2: MAC CE, Option #3: Time pattern (e.g. DRX like). In configuration of a BWP, a UE is configured with BWP in terms of PRBs (physical resource blocks). The offset between BWP and a reference point is implicitly or explicitly indicated to UE. Common PRB indexing is used at least for DL BWP configuration in RRC connected state, the reference point is PRB 0, which is common to all the UEs sharing a wideband CC from network perspective, regardless of whether they are NB, CA, or WB UEs. PRB 0 is configured by high layer signaling. The common PRB indexing is for maximum number of PRBs for a given numerology defined in Table 4.3.2-1 in 38.211.

Since several numerologies will be used in NR, typically below 6 GHz, achieving equivalent coverage for all numerologies increases the complexity of determining a physical uplink control channel configuration. NR will use PUCCH configurations of different lengths. Short PUCCH and Long PUCCH for have been proposed in NR. A Short PUCCH is typically 1 or 2 symbols long and is often placed in the end of a slot interval in second last or last symbol but may also be distributed over a slot interval, and a Long PUCCH is 4 symbols long or more (4-14 symbols) and it can be extended or repeated to extend over several slots. Different PUCCH configurations for the different PUCCH formats have been proposed. PUCCH format 0 and 2 uses a short transmission format (1 or 2 symbols) starting on symbol 0-13, while PUCCH format 1, 3 and 4 uses a long transmission format (4-14 symbols) starting on symbols 1-10. To achieve equivalent coverage for all numerologies, it could be considered that PUCCH configurations of 1 ms must exist independent of numerology (at least for sub-6 GHz). However, one could also argue that 1 ms is needed for large deployments and then only 15 kHz is ok. Thus, with 15 kHz longest PUCCH must be around 14 symbols long, and for 2\hat{ }n*15 kHz 14*2\hat{ }n symbols.

The current disclosure provides solutions to the above mentioned problems and drawbacks by adjusting the physical uplink control channel structure or format, depending on the numerology used. Since NR may use slots more than subframes for scheduling transmissions and since the slots defined in NR may be of a shorter duration than a slot or subframe in LTE, a long PUCCH without stretching across multiple slots would be limited in duration to the length of a single slot (a slot may even be longer than 1 ms—for numerologies with <15 kHz subcarrier spacing, SCS). To be able to reuse LTE site grid for NR deployments a similar PUCCH duration as in LTE (1 ms) is needed—at least for some numerologies that are likely to be used in deployments reusing LTE site grid. It has been agreed to support PUCCH repetition across multiple slots. It is thus proposed to calculate the number of slots in a PUCCH as function of the PUCCH numerology, most generally Nₛₗₒₜ=f(Num) or (the number of slots as a function of the PUCCH numerology) or alternatively the number of PUCCH symbols in the PUCCH Nₛₗₒₜ=f(Num) or (the number of PUCCH symbols in the PUCCH as a function of the PUCCH numerology). The current disclosure comprises methods and apparatuses for determining and for transmitting a physical uplink control channel, also referred to as PUCCH, for transmitting e.g. uplink control information (UCI) on the PUCCH from a wireless device (such as a UE) to radio node (such as a base station), and for determining a physical uplink control channel structure, also referred to as a PUCCH structure. Methods and apparatuses for receiving a PUCCH in a radio node are also disclosed. In a first embodiment, the PUCCH structure (PUCCH length) may be determined or configured. For Short PUCCH (of 1 or 2 symbols), one could configure Short PUCCH1 (1 symbol long) or Short PUCCH2 (2 symbols long), but for Long PUCCH, there are more options since the Long PUCCH has 4-14 symbols. Thus, in one aspect of the current disclosure, the Long PUCCH length is semi-statically configured. There may be several, such as 2 or 3, different long PUCCH formats each coming with 4-14 symbols length, for different payload ranges. One could thus configure Long PUCCH 1, 2 or 3 (PUCCH format), and then the length of the PUCCH, e.g. 12 symbols, the length being a part of the PUCCH structure. The RRC specification, for example, may define a table, which could link the numerology to the physical uplink control channel structure (e.g. for the long PUCCH), such as for example to the length of the physical uplink control channel. A wireless device using or being configured with a certain numerology for PUCCH (or frequency subcarrier spacing relating to a certain numerology) could use said information to find parameters of the physical uplink control channel structure, such as the PUCCH length, by using the table, e.g. by mapping the used or configured numerology (subcarrier spacing) to a certain physical uplink control channel structure (e.g. PUCCH length).

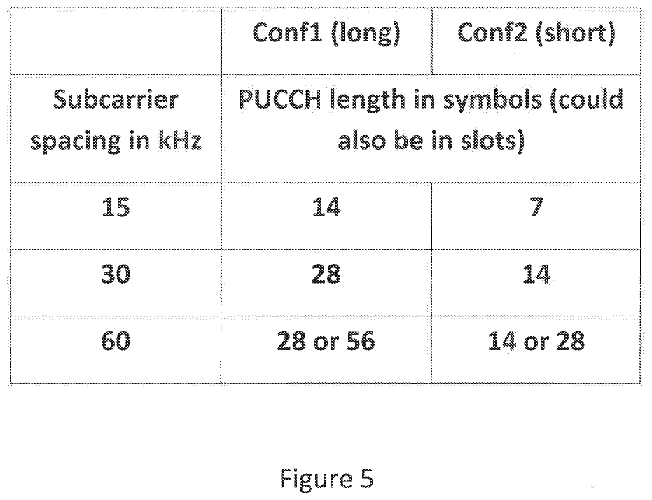

For example, the RRC specification may define a table linking the numerology, or the subcarrier spacing used in the numerology, to different PUCCH structures (such as PUCCH lengths), which may also depend on the one or more configurations of long PUCCH. As an example shown in FIG. 5, different subcarrier spacings of different numerologies are related to two configurations for the long PUCCH (“long” Long PUCCH (Conf 1) and “short” Long PUCCH (Conf 2)), where the different configurations maps to different durations of the PUCCH for each numerology, the PUCCH length being in number of symbols or slots. For each numerology, at least one PUCCH length is defined, and for each PUCCH configuration, (e.g. Conf 1, 2 or 3), one or more lengths could be defined for each numerology, e.g. Conf1 in the table in FIG. 5 would be 1 ms for 15 and 30 kHz and 0.5 or 1 ms for 60 kHz (one would then need to decide if it should be 0.5 or 1 ms), which would give different PUCCH lengths for different numerologies. For example, a first configuration relating to a first Long PUCCH (denoted Conf 1 in the table in FIG. 5) and a second configuration relating to a second Long PUCCH (denoted Conf 2 in the table in FIG. 5) have an increased duration or length in symbols or slots if the subcarrier spacing increases. A third configuration, Conf3, for Long PUCCH configuration 3 is also possible to include in the table (not shown). As seen in FIG. 5, as an example, a numerology using a subcarrier spacing of 15 kHz (sometimes referred to as a reference or default (zero) numerology) may have a first Long PUCCH configuration (Conf1) of 14 symbols while using a numerology with a 30 kHz subcarrier spacing may give a first Long PUCCH configuration of 28 symbols in this case. A tabulated standard, such as in a future NR spec (3GPP technical specification of the telecommunication standard relating to NR) could then define (e.g. in a table), for each numerology or frequency subcarrier spacing, at least one PUCCH length, or at least one PUCCH length relating to each physical uplink control channel configuration (e.g. Conf 1, Conf2 and Conf3) for each numerology, as exemplified in FIG. 5. Instead of explicitly selecting the row in the table, the anyway signaled numerology is used to select the configuration without the need to add extra signaling bits (since the numerology is already signaled). In one example aspect of the embodiment, a bit string is sent to the as part of the RRC configuration, which may have one bit is reserved for PUCCH repetition configuration/structure. Depending on PUCCH numerology the bit means different things, e.g. 15 kHz: 0:14 symbols, 1: 28 symbols, 60 kHz: 0: 56 symbols, 1:112 symbols. In both cases “0” means 1 ms and “1” means 2 ms but this requires different number of symbols in the different numerologies. Another possibility would be 15 kHz: 0:1 repetition, 1: 2 repetition 60 kHz: 0:4 repetition, 1:8 repetition (repetition also counts the original). I.e. the same bit field in the configuration is interpreted differently by the wireless device depending on the numerology. A wireless device may be configured with different BWPs, where each UL BWP being associated with a numerology which is used by PUSCH/PUCCH. For each UL BWP configuration per component carrier, the associated numerology is applied to PUCCH transmission. Accordingly, the UL numerology configuration used, i.e. the numerology of the UL BWP configuration, may thus be applied to PUCCH, i.e. for transmitting the PUCCH. The wireless device may also be configured with different PUCCH configurations of different length. Hence, the numerology of the UL BWP used for PUCCH may be linked to the PUCCH structure, such as the PUCCH length, using a table. Thus, knowledge of the UL BWP numerology used for transmitting UCI on PUCCH may be used to obtain information about the PUCCH structure, such as the PUCCH length. NR may further define slot configurations, i.e. slot intervals of e.g. 14 symbols duration, with zero, one or two special symbols depending on the numerology (two for 15 kHz and one for 30 kHz and one or zero for above 30 kHz). The NR specification defines at least one length for each numerology and each slot configuration. Thus, for each PUCCH numerology a PUCCH slot configuration could be added to the information obtained/received by the wireless device. Numerology together with slot configuration would then indicate the PUCCH structure. The PUCCH structure could either deliver the number of PUCCH symbols (as shown in table 5) or the number of slots ([1 1; 2 2; (2 or 4) (2 or 4)] in Matlab notation for the table 5). If number of symbols is returned (determined PUCCH length in number of symbols) one needs also to consider extended cyclic prefix (CP), if defined for a numerology. With extended CP, a slot contains 12 instead of 14 symbols. The PUCCH Conf 1 and 2 could be independent of slot configuration, i.e. they could be cross configured.

In a second embodiment the UE is configured with the actual numerology (n value of the numerology) and a physical uplink control channel configuration, e.g. configuration 1 or 2 (Conf1 or Conf2), from which it calculates the length of the physical uplink control channel, PUCCH.

For example, for a PUCCH reference (or default) numerology, e.g. 15 kHz (n_Ref=), RRC defines Conf1=14 symbols (1 ms) and Conf2=7 symbols (0.5 ms). The length (duration in time domain) of the physical uplink control channel may thus be computed as: L=14*2\hat{ }(n−n_Ref), where n_Ref is n value for reference numerology (could also ne denoted no). The same formula can be applied based on 7 symbols or slots instead of symbols. For a reference numerology, e.g. 2ⁿ^{₀}·15 kHz (typically n₀=0), a reference PUCCH configuration is defined, e.g. spanning 14 symbols (1 ms). For a numerology 2²·15 kHz the number of symbols could be computed according to N_{symb,n}=2⁽ⁿ⁻ⁿ^{₀}⁾·14 or typically N_{symb,n}=2²·14 (n₀=0). Instead or in addition a reference configuration could be based on 7 symbols, in this case N_{symb,n}=2⁽ⁿ⁻ⁿ^{₀}⁾·7 applies. The same comment with respect to extended CP applies as above, with extended CP, a slot contains 6 or 12 instead of 7 or 14 symbols. In a further aspect of the embodiment, Instead of determining the number of symbols a formula could be used to determine the number of slots in numerology n, e.g. N_{slot,n}=2⁽ⁿ⁻ⁿ^{₀}⁾−N_{slot,n_0} with N_{slot,n}_{₀}, the number of PUCCH slots in the reference numerology no.

In a third embodiment, the PUCCH structure, more particularly the length (duration in time) in number of symbols or slots of the PUCCH could be computed (determined) by the wireless device based on an obtained, such as received, information regarding the duration of the physical uplink control channel configuration in seconds, such as milliseconds. In the received or obtained information the physical uplink control channel configuration length is defined in milliseconds (msec or ms) instead of number of symbols/slots. For example, RRC defines PUCCH length in msec (e.g. Conf1=1 ms, Conf2=0.5 ms) and together with numerology the wireless device can calculate slots or symbols of PUCCH. Thus, a PUCCH duration (e.g. in milliseconds) is defined independent of numerology, and used together with numerology to calculate the duration in number of symbols or slots.

The PUCCH duration in milliseconds, depending on the PUCCH configuration (e.g. Conf 1 or 2), together with information regarding the numerology (or subcarrier spacing relating to a numerology) is thus combined to determine (e.g. calculate) the number of slots or symbols of the PUCCH. For example, the number of PUCCH slots can then be calculated as N_{slot,n}=T₀/T_{slot,n} with T₀ as the defined PUCCH duration (e.g. 1 ms) and T_{slot,n} as the slot duration of numerology n. The PUCCH duration T₀ may thus be dependent on the physical uplink channel configuration, e.g. configuration 1 or 2 (Conf 1 or 2), which is then defining a time duration in milliseconds instead of number of symbols or slots. The number of symbols can be calculated according to N_{symb,n}=N_{stot,n}·L=T₀/T_{slot,n}·L with L the number of symbols per slot, e.g. 7 or 14 f (normal CP) or 6 or 12 (extended CP). The calculation (determination) of slots or symbols may thus be performed in the wireless device.

Example Operations

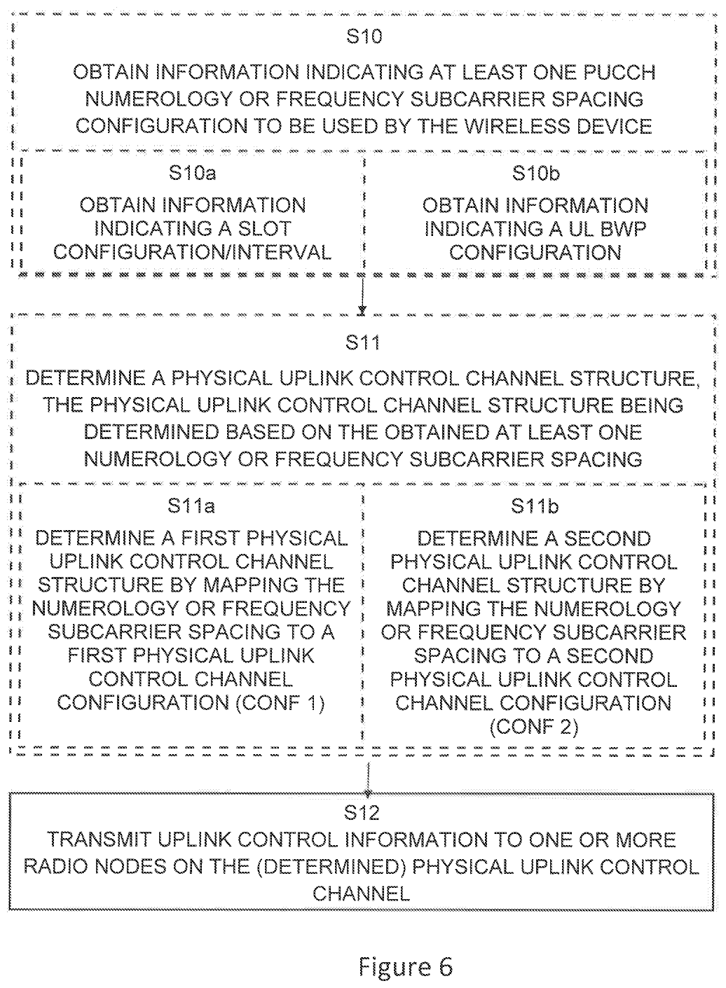

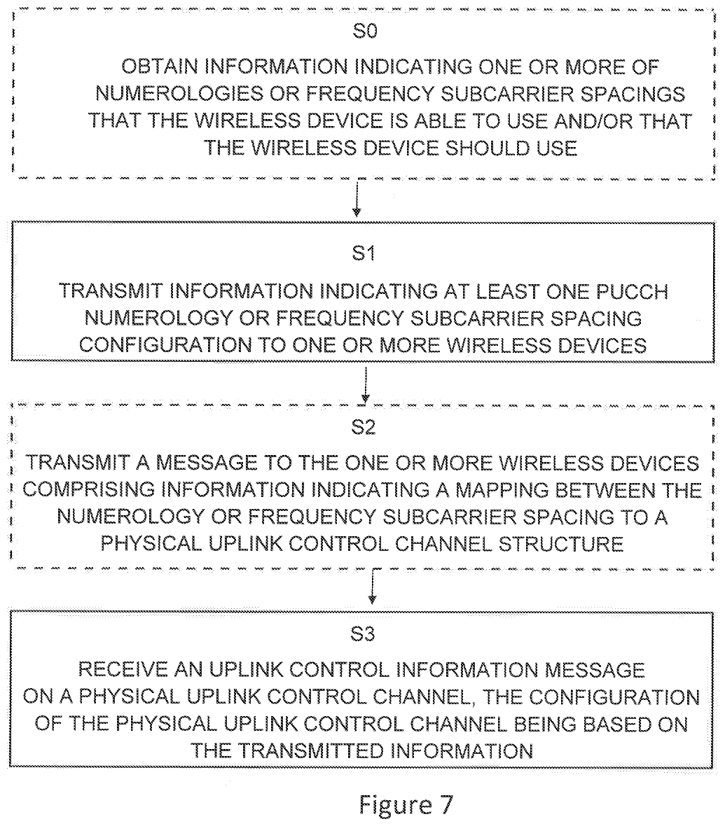

The proposed methods will now be described in more detail referring to FIGS. 6 and 7. It should be appreciated that FIGS. 6 and 7 comprise some operations and modules which are illustrated with a solid border and some operations and modules which are illustrated with a dashed border. The operations and modules which are illustrated with solid border are operations which are comprised in the broadest example embodiment. The operations and modules which are illustrated with dashed border are example embodiments which may be comprised in, or a part of, or are further embodiments which may be taken in addition to the operations and modules of the broader example embodiments. It should be appreciated that the operations do not need to be performed in order. Furthermore, it should be appreciated that not all of the operations need to be performed.

FIG. 6 illustrates a method, performed in a wireless device in a wireless communication system, for transmitting a physical uplink control channel, also referred to as PUCCH, (for transmitting information on the PUCCH), the method comprises: transmitting (S12) uplink data or control information, in particular uplink control information, UCI, to one or more radio nodes, on a physical uplink control channel having a physical uplink control channel structure, the physical uplink control channel structure used being based on at least one numerology or frequency subcarrier spacing configured for or used by the wireless device for transmitting the physical uplink control channel. The transmission being on a physical uplink control channel using a physical uplink control channel structure that is being based on which numerology (PUCCH numerology), such as which numerology n, or frequency subcarrier spacing, that is being configured for the wireless device (that the wireless device is being configured with) and/or that is being used by the wireless device, wherein the frequency subcarrier spacing may be linked to a certain numerology (a numerology using said frequency subcarrier spacing). The physical uplink channel structure could define for example the length, i.e. the duration in time, of the physical uplink control channel, or the frequency range, or any other parameter related to the structure of the channel. The length, or time duration may be in number of symbols (time symbols), number of slots or (number of) milliseconds. The PUCCH structure could also be related to (or even referred to) a PUCCH format, and may comprise the properties of a PUCCH format, such as suitable payloads. The radio nodes to which the PUCCH is transmitted could be for example one or more of a wireless device, a network node, a cloud node or a base station, such as a gNB.

The method could further include obtaining (S10) information indicating at least one numerology or frequency subcarrier spacing configuration to be used by the wireless device. In a certain aspect of the embodiment, obtaining (S10) information indicating a numerology or frequency subcarrier spacing comprises receiving the information from a network node, such as for example a base station or cloud node, e.g. in an RRC message. The numerology could also be determined by the wireless device itself. The method could further comprise determining (S11) a physical uplink control channel structure, the physical uplink control channel structure being linked to or determined based on at least one numerology or frequency subcarrier spacing configured for or used by the wireless device. In one embodiment of the invention, the PUCCH structure is determined based on the numerology (or frequency subcarrier spacing) and one or more PUCCH configurations. The configuration may be an UL BWP configuration to be used by the wireless device.

In one aspect, each numerology or frequency subcarrier spacing maps to at least one physical uplink control channel configuration and, determining (S11) a physical uplink control channel structure comprises mapping the numerology or frequency subcarrier spacing to the at least one physical uplink control channel configuration. In one aspect of the invention, each numerology or frequency subcarrier spacing maps to either a first physical uplink control channel configuration (Conf 1) or a second physical uplink control channel configuration (Conf 2), the method further comprising determining (Sila) a first physical uplink control channel structure by mapping the numerology or frequency subcarrier spacing to a first physical uplink control channel configuration (Conf 1), or determining (S11b) a second physical uplink control channel structure by mapping the numerology or frequency subcarrier spacing to a second physical uplink control channel configuration (Conf 2). The mapping may be performed using a table, wherein the table defines the physical uplink control channel structure for the one or more physical uplink control channel configurations, for each configured or used numerology or frequency subcarrier spacing. The mapping may be done e.g. by using a table which may be received by the wireless device, e.g. transmitted to (received by) the wireless device from e.g. a network node, such as in an RRC message. The table may also be stored in the memory of the wireless device, and the RRC message may define a PUCCH configuration and/or numerology to use in the wireless device to do the mapping and retrieve the PUCCH structure, such as PUCCH length. The table may thus define one or more PUCCH structures, such as PUCCH lengths, for each numerology and PUCCH configuration, as exemplified in FIG. 5. Thus, the mapping is done using a table, wherein the table may define the physical uplink control channel structure as the length (time duration) in number of symbols, slots, samples or milliseconds of the physical uplink control channel, for each of the one or more, such as two physical uplink control channel configurations, Conf 1 and Conf 2, and for each configured or used numerology or frequency subcarrier spacing. In one aspect determining (S11) a physical uplink control channel structure comprises determining the length (time duration) of the physical uplink control channel, in number of symbols, slots or samples, based on the configured/used numerology or frequency subcarrier spacing and a first physical uplink control channel configuration (Conf 1) or a second physical uplink control channel configuration (Conf 2) configured for the wireless device. The number or normal and special symbols may be indicated explicitly or implicitly.

For example, the first PUCCH configuration, Conf 1, may relate to a longer physical uplink control channel configuration, and a second PUCCH configuration, Conf 2, may relate to a shorter physical uplink control channel configuration. In a further embodiment, physical uplink control channel structure is determined based on the obtained or used numerology or frequency subcarrier spacing together with a slot configuration or slot interval (number of symbols per slot). In one aspect, obtaining (S10) information indicating a numerology or frequency subcarrier spacing further comprises obtaining (S10a) a slot configuration or slot interval.

In a further embodiment, the wireless device is configured with the numerology (n value of the numerology) and the PUCCH configuration, and may use those to determine or calculate/compute the elements of the PUCCH structure, such as the PUCCH length. The length is determined based on the PUCCH configuration and the relation between the n value of the configured numerology and the n value of a reference (default/zero) numerology. In an aspect of the embodiment the first physical uplink control channel configuration (Conf 1) is 14 symbols for a reference numerology and the second physical uplink control channel configuration (Conf 2) is 7 symbols for a reference numerology, and wherein the physical uplink control channel length, L, is determined according to:

L=142\hat{ }(n−n_0), if a first physical uplink control channel configuration (Conf 1) of 14 symbols is configured or L=7.2\hat{ }(n−n_0), if a second physical uplink control channel configuration (Conf 2) of 7 symbols is configured, where n is the n value for the configured/used numerology and n_0 is the n value for the reference numerology and the length, L, is in number of symbols; or L=N_(slot,n)=2\hat{ }((n−n_0))·N_(slot,n_0), where L is in number of slots, N_(slot,n) is the length in number of slots for numerology n, and N_(slot,n_0) is the number slots in the reference numerology n_0. When using an extended CP, Conf 1 and 2 may be 12 and 6 symbols respectively, and the formulas could then read L=12*2\hat{ }(n−n_0) and L=6*2\hat{ }(n−n_0) respectively.

In a further embodiment the PUCCH configuration and or PUCCH duration is received in milliseconds instead of slots or symbols. In one aspect obtaining (S10) information indicating a numerology or frequency subcarrier spacing further comprises obtaining (S10b) an uplink bandwidth part configuration associated with a numerology.

In one aspect of the methods the symbols are OFDM symbols or SC-FDMA symbols, and the physical uplink control channel structure is a PUCCH structure for NR.

A corresponding method, performed in a network node, for receiving a transmission on a physical uplink control channel, will now be described referring to FIG. 7. FIG. 7 illustrates a method for use in a network node in a wireless communication system for receiving a physical uplink control channel, the method comprising transmitting (S1) information indicating at least one physical uplink control channel numerology or frequency subcarrier spacing configuration to at least one wireless device, and receiving (S3), from the at least one of the wireless device, an uplink control information message on a physical uplink control channel, the physical uplink control channel structure being based on the transmitted information. In one aspect, the method further comprises obtaining (S0) information indicating one or more of numerologies or frequency subcarrier spacings that the wireless device is able to use and/or that the wireless device should use wherein the obtaining (S0) information may comprise determining at least one numerology or frequency subcarrier spacing to be used by the one or more wireless devices in the network node or receiving the at least one numerology or frequency subcarrier spacing from another node. In one aspect, the transmitted (S1) information further comprises a slot configuration or bandwidth part configuration.

In one embodiment the method may further comprise transmitting (S2) a message to the one or more wireless devices comprising information indicating a mapping between the numerology or frequency subcarrier spacing to a physical uplink control channel structure. The transmitted message may further comprise a physical uplink control channel configuration, and the physical uplink control channel structure may be based both on the numerology or frequency subcarrier spacing and the physical uplink control channel configuration. In a further aspect, the transmitted message comprises a table or indicated a mapping in a table stored in the memory of the wireless device. The physical uplink control channel structure of the above mentioned methods may define the length (time duration) of the physical uplink control channel. In a further aspect, the network node is a gNB.

Example Node Configurations

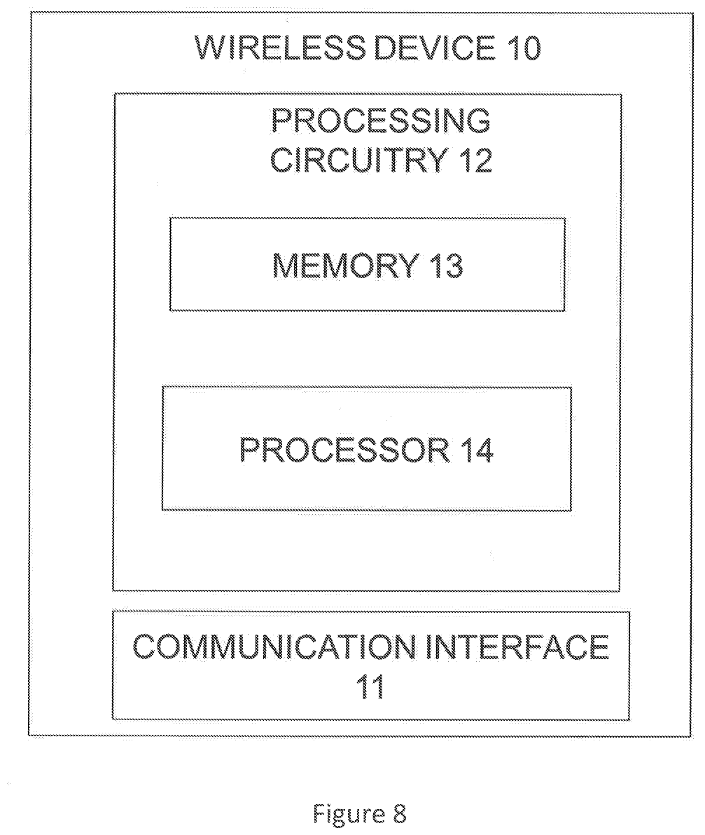

Turning now to FIG. 8, which is a schematic diagram that illustrates some modules of an example embodiment of a wireless device being configured for transmitting a physical uplink control channel and/or determining a physical uplink control channel structure. The wireless device is configured to implement all aspects of the methods described in relation to FIG. 6. The wireless device 10 comprises a radio communication interface (i/f) 11 configured for communication with a network node. The radio communication interface 11 may be adapted to communicate over one or several radio access technologies. If several technologies are supported, the node typically comprises several communication interfaces, e.g. one WLAN or Bluetooth communication interface and one cellular communication interface, including LTE or NR.

The wireless device 10 comprises a controller, CTL, or a processing circuitry 12 that may be constituted by any suitable Central Processing Unit, CPU, microcontroller, Digital Signal Processor, DSP, etc. capable of executing computer program code. The computer program may be stored in a memory, MEM 13. The memory 13 can be any combination of a Read And write Memory, RAM, and a Read Only Memory, ROM. The memory 13 may also comprise persistent storage, which, for example, can be any single one or combination of magnetic memory, optical memory, or solid state memory or even remotely mounted memory. According to some aspects, the disclosure relates to a computer program comprising computer program code which, when executed, causes a wireless device to execute the methods described above and below. According to some aspects the disclosure pertains to a computer program product or a computer readable medium holding said computer program. The processing circuitry may further comprise both a memory 13 storing a computer program and a processor 14, the processor being configured to carry out the method of the computer program.

One embodiment includes a wireless device (10), configured to operate in a wireless communication system (100), configured for transmitting a physical uplink control channel to a network node (20), the wireless device (10) comprising a communication interface (11) and processing circuitry (12) configured to cause the wireless device (10) to transmit uplink control Information to one or more radio nodes on a physical uplink control channel having a physical uplink control channel structure, the physical uplink control channel structure used being based on at least one numerology or frequency subcarrier spacing used by the wireless device (10) for transmitting the physical uplink control channel. The processing circuitry 12 is configured to cause the wireless device 10 to transmit a PUCCH, the PUCCH structure being based at least on the numerology configured for or received by the wireless device. According to some aspects, the processing circuitry 12 is configured to cause the wireless device 10 to obtain information indicating at least one numerology or frequency subcarrier spacing to be used by the wireless device (10), and determine a physical uplink control channel structure, the physical uplink control channel configuration being determined based on at least one numerology or frequency subcarrier spacing used by the wireless device (10).

According to some aspects, wherein each numerology or frequency subcarrier spacing maps to either a first physical uplink control channel configuration or a second physical uplink control channel configuration, and wherein the processing circuitry (12) is further configured to: determine a first physical uplink control channel structure by mapping the numerology or frequency subcarrier spacing to a first physical uplink control channel configuration; or determine a second physical uplink control channel structure by mapping the numerology or frequency subcarrier spacing to a second physical uplink control channel configuration.

Further, embodiments relating to a host computer and activities therein, is also comprised in the current disclosure. A host computer (or server, or application server), which is under the ownership or control of a service provider, or which is operated by the service provider or on their behalf is connected to the RAN (e.g., cellular network) via the core network.

In one aspect is comprised a user equipment (UE) or wireless device configured to communicate with a base station or network node, the UE comprising a radio interface and processing circuitry configured to: obtain information indicating at least one numerology or frequency subcarrier spacing configuration to be used by the wireless device;

determine a physical uplink control channel structure, the physical uplink control channel structure being determined based on at least one numerology or frequency subcarrier spacing used by the wireless device; and transmit uplink control information to one or more radio nodes on a physical uplink control channel using the determined physical uplink control channel structure. In a further aspect is comprised a communication system including a host computer comprising: a communication interface configured to receive user data originating from a transmission from a user equipment (UE) to a base station, wherein the UE comprises a radio interface and processing circuitry, the UE's processing circuitry configured to: obtain information indicating at least one numerology or frequency subcarrier spacing configuration to be used by the wireless device; determine a physical uplink control channel structure, the physical uplink control channel structure being determined based on at least one numerology or frequency subcarrier spacing used by the wireless device; and transmit uplink control information to one or more radio nodes on a physical uplink control channel using the determined physical uplink control channel structure. In one aspect, the communication system further includes the UE. In another aspect, the communication system further includes the base station, wherein the base station comprises a radio interface configured to communicate with the UE and a communication interface configured to forward to the host computer the user data carried by a transmission from the UE to the base station. In a further aspect the processing circuitry of the host computer is configured to execute a host application; and the UE's processing circuitry is configured to execute a client application associated with the host application, thereby providing the user data. In a a further aspect the processing circuitry of the host computer is configured to execute a host application, thereby providing request data; and the UE's processing circuitry is configured to execute a client application associated with the host application, thereby providing the user data in response to the request data.

In a further embodiment is defined a method implemented in a communication system including a host computer, a base station and a user equipment (UE), the method comprising: at the host computer, receiving user data transmitted to the base station from the UE, wherein the UE obtains information indicating at least one numerology or frequency subcarrier spacing configuration to be used by the wireless device; determines a physical uplink control channel structure, the physical uplink control channel structure being determined based on at least one numerology or frequency subcarrier spacing used by the wireless device; and transmits uplink control information to one or more radio nodes on a physical uplink control channel using the determined physical uplink control channel structure. In one aspect, the method comprising, at the UE, providing the user data to the base station. The method further comprising: at the UE, executing a client application, thereby providing the user data to be transmitted; and at the host computer, executing a host application associated with the client application. The method further comprising: at the UE, executing a client application; and at the UE, receiving input data to the client application, the input data being provided at the host computer by executing a host application associated with the client application, wherein the user data to be transmitted is provided by the client application in response to the input data.

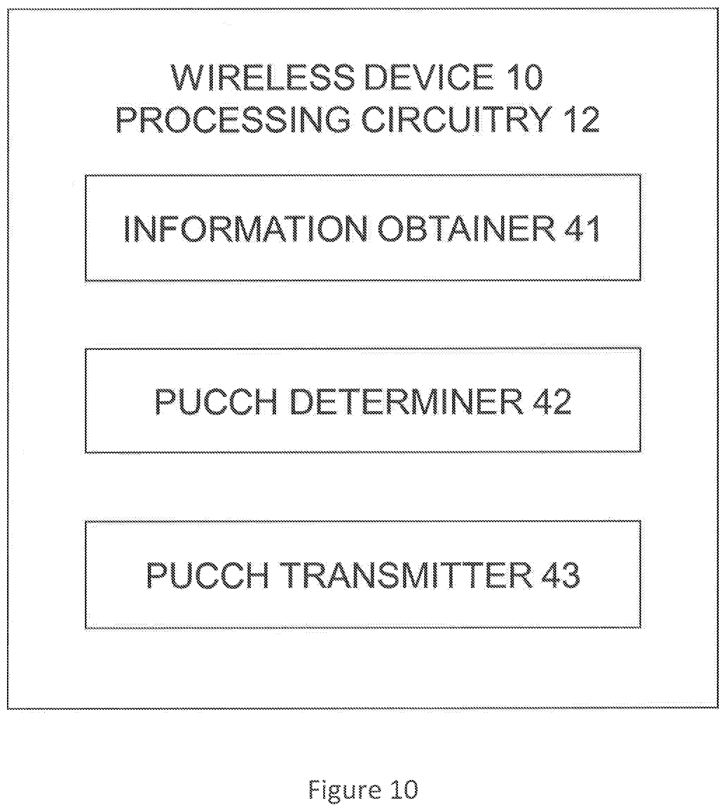

According to some aspects the processing circuitry 12 or the wireless device 10 comprises modules 41-43 configured to perform the methods described above. The modules are illustrated in FIG. 10. The modules are implemented in hardware or in software or in a combination thereof. The modules are according to one aspect implemented as a computer program stored in a memory 13 which run on the processing circuitry 12.

According to some aspects the wireless device 10 or the processing circuitry 12 comprises a information obtainer module 41 configured to obtain, such as receive, information indicating at least one numerology or frequency subcarrier spacing configuration to be used by the wireless device.

According to some aspects the wireless device 10 or the processing circuitry 12 comprises a determiner module 42 configured to determine a physical uplink control channel structure, the physical uplink control channel structure being determined based on the received information, i.e. at least one numerology or frequency subcarrier spacing configured for/used by the wireless device. According to some aspects the wireless device 10 or the processing circuitry 12 comprises a transmitter module 43 configured to transmit uplink control information to one or more radio nodes on a physical uplink control channel using the determined physical uplink control channel structure.

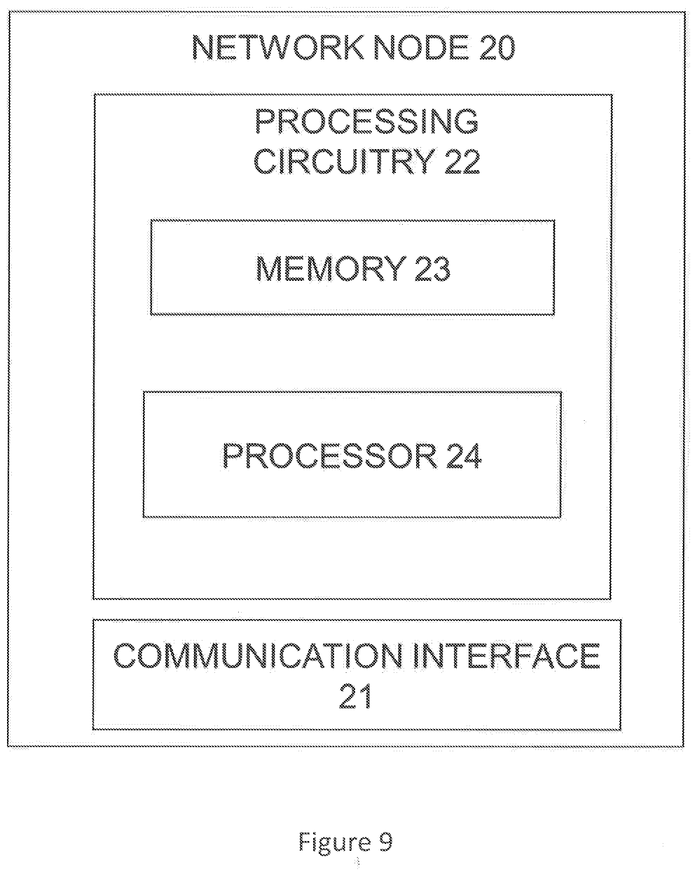

FIG. 9 illustrates an example of a network node 20, which incorporates some of the example embodiments discussed above. FIG. 9 discloses a network node 20 being configured for receiving a PUCCH (a transmission of UCI on the PUCCH) from a (one or more) wireless device 10. As shown in FIG. 9, the network node 20 comprises a radio communication interface or radio circuitry 21 configured to receive and transmit any form of communications or control signals within a network. It should be appreciated that the communication interface (radio circuitry) 21 is according to some aspects comprised as any number of transceiving, receiving, and/or transmitting units or circuitry. It should further be appreciated that the radio circuitry 21 can e.g. be in the form of any input/output communications port known in the art. The radio circuitry 21 e.g. comprises RF circuitry and baseband processing circuitry (not shown).

The network node 20 according to some aspects further comprises at least one memory unit or circuitry 23 that is in communication with the radio circuitry 21. The memory 23 can e.g. be configured to store received or transmitted data and/or executable program instructions. The memory 23 is e.g. configured to store any form of contextual data. The memory 23 can e.g. be any suitable type of computer readable memory and can e.g. be of volatile and/or non-volatile type. The network node 20 further comprises processing circuitry 22 which configured to cause the network node 20 to transmit information indicating at least one numerology or frequency subcarrier spacing to one or more wireless devices, and to receive an uplink control information message on a physical uplink control channel, the structure of the physical uplink control channel being based on the transmitted information.

The processing circuitry 22 is e.g. any suitable type of computation unit, e.g. a microprocessor, Digital Signal Processor, DSP, Field Programmable Gate Array, FPGA, or Application Specific Integrated Circuit, ASIC, or any other form of circuitry. It should be appreciated that the processing circuitry need not be provided as a single unit but is according to some aspects provided as any number of units or circuitry. The processing circuitry may thus comprise both a memory 23 for storing a computer program and a processor 24, the processor being configured to carry out the method of the computer program.

The controller, CTL, or processing circuitry 22 is according to some aspects capable of executing computer program code. The computer program is e.g. stored in a memory, MEM, 23. The memory 23 can be any combination of a Read And write Memory, RAM, and a Read Only Memory, ROM. The memory 23 in some situations also comprise persistent storage, which, for example, can be any single one or combination of magnetic memory, optical memory, or solid state memory or even remotely mounted memory. It should be appreciated that the processing circuitry need not be provided as a single unit but is according to some aspects provided as any number of units or circuitry. According to some aspects, the disclosure relates to a computer program comprising computer program code which, when executed, causes a network node to execute the methods described above and below.

In one embodiment is comprised a network node (20), configured to operate in a wireless communication system (100), configured for receiving a physical uplink control channel from a wireless device (10), the network node (20) comprising a communication interface (21); and processing circuitry (22) configured to cause the network node (20) to transmit information indicating at least one numerology or frequency subcarrier spacing to one or more wireless devices; to receive an uplink control information message on a physical uplink control channel, the structure of the physical uplink control channel being based on the transmitted information. According to some aspects, the processing circuitry 22 is configured obtain information indicating one or more of numerologies or frequency subcarrier spacings that the wireless device is able to use and that the more wireless device (10) should use; and transmit a message to the wireless device (10) comprising information indicating how to map the numerology or frequency subcarrier spacing to a physical uplink control channel structure.

The wireless device comprises modules (41-44) operative to receive information indicating a frequency subcarrier spacing (module 41), the frequency subcarrier spacing being based at least on the number of scheduled spatially multiplexed wireless devices in the multi carrier system; determine a sequence of a reference signal based at least on the received information (module 42); and transmit the reference signal to a network node in resource elements of a reference signal carrying symbol using the received information (module 44).

The network node comprises modules (51-54) operative to receive a PUCCH, to obtain information indicating one or more of numerologies or frequency subcarrier spacings that the wireless device is able to use and that the more wireless device (10) should use (module 51), transmit information indicating at least one numerology or frequency subcarrier spacing to one or more wireless devices (module 52); transmit a message to the wireless device (10) comprising information indicating a mapping between the numerology or frequency subcarrier spacing to a physical uplink control channel structure (module 53); and receive an uplink control information message on a physical uplink control channel, the structure of the physical uplink control channel being based on the transmitted information (module 54).

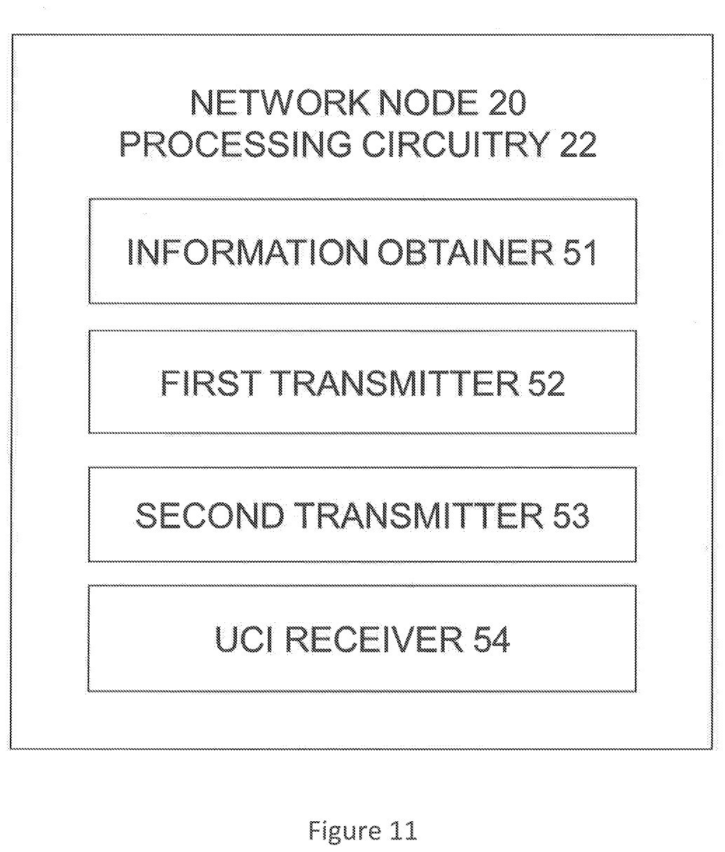

According to some aspects the network node 20 or the processing circuitry 22 comprises modules configured to perform the methods described above. The modules are implemented in hardware or in software or in a combination thereof. The modules are illustrated in FIG. 11. The modules are according to one aspect implemented as a computer program stored in a memory 23 which run on the processing circuitry 22.

According to some aspects the network node 20 or the processing circuitry 22 comprises an information obtainer module 51 configured to obtain information indicating one or more of numerologies or frequency subcarrier spacings that the wireless device is able to use and that the more wireless device (10) should use.

According to some aspects the network node 20 or the processing circuitry 22 comprises a first transmitter module 52 configured to transmit information indicating at least one numerology or frequency subcarrier spacing to one or more wireless devices.

According to some aspects the network node 20 or the processing circuitry 22 comprises a second transmitter module 53 configured to transmit a message to the wireless device (10) comprising information indicating a mapping between the numerology or frequency subcarrier spacing to a physical uplink control channel structure.

According to some aspects the network node 20 or the processing circuitry 22 comprises a receiver module 54 configured to receive receive an uplink control information message on a physical uplink control channel, the structure of the physical uplink control channel being based on the transmitted information.

The content of this disclosure thus enables to transmit a PUCCH with good coverage for all numerologies by adapting (determining) the PUCCH structure, such as PUCCH length, based on the numerology used for transmitting the PUCCH.

Aspects of the disclosure are described with reference to the drawings, e.g., block diagrams and/or flowcharts. It is understood that several entitles in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same Item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

According to some aspects is provided a computer program comprising computer program code which, when executed in a wireless device, causes the wireless device to execute the methods in the wireless device described above.

According to some aspects is provided a computer program comprising computer program code which, when executed in a network node, causes the network node to execute the methods in the network node described above.

According to some aspects is provided a carrier containing any one of the computer programs mentioned above, wherein the carrier is one of an electronic signal, optical signal, radio signal, or computer readable storage medium.

### Embodiments

1. A method for use in a wireless device in a wireless communication system for transmitting a physical uplink control channel, the method comprising:
   transmitting (S12) uplink control information to one or more radio nodes on a physical uplink control channel having a physical uplink control channel structure, the physical uplink control channel structure used being based on at least one numerology or frequency subcarrier spacing configured for or used by the wireless device for transmitting the physical uplink control channel.
2. The method of embodiment 1 further comprising:
   determining (S11) a physical uplink control channel structure, the physical uplink control channel structure being determined based on at least one numerology or frequency subcarrier spacing configured for or used by the wireless device.
3. The method of embodiment 1 further comprising:
   obtaining (S10) information indicating at least one numerology or frequency subcarrier spacing configuration to be used by the wireless device.
4. The method of embodiment 3, wherein the obtained (S10) information indicating a numerology or frequency subcarrier spacing comprises receiving the information from a network node.
5. The method of embodiments 2-4, wherein each numerology or frequency subcarrier spacing maps to at least one physical uplink control channel configuration, and determining (S11) a physical uplink control channel structure comprises mapping the numerology or frequency subcarrier spacing to the at least one physical uplink control channel configuration.
6. The method of embodiment 5, wherein each numerology or frequency subcarrier spacing maps to either a first physical uplink control channel configuration (Conf 1) or a second physical uplink control channel configuration (Conf 2), further comprising:
   determining (S11a) a first physical uplink control channel structure by mapping the numerology or frequency subcarrier spacing to a first physical uplink control channel configuration (Conf 1), or
   determining (S11b) a second physical uplink control channel structure by mapping the numerology or frequency subcarrier spacing to a second physical uplink control channel configuration (Conf 2).
7. The method of embodiments 5-6, wherein the mapping is done using a table, wherein the table defines the physical uplink control channel structure for the one or more physical uplink control channel configuration, for each configured or used numerology or frequency subcarrier spacing.
8. The method of embodiments 6-7, wherein the mapping is done using a table, wherein the table defines the physical uplink control channel structure as the length (time duration) in number of symbols, slots or milliseconds of the physical uplink control channel, for each of the two physical uplink control channel configurations, Conf 1 and Conf 2, and for each configured or used numerology or frequency subcarrier spacing.
9. The method of embodiments 7-8, wherein the table is received by the wireless device, for example in an RRC message, or stored in the memory of the wireless device.
10. The method of embodiment 9, wherein the table is stored in the memory of the wireless device and the physical uplink control channel configuration and the physical uplink control channel numerology are received by the wireless device, e.g. in an RRC message.
11. The method of embodiments 1-10, wherein the one or more radio nodes constitutes one or more of a wireless device, a network node, a cloud node or a base station, such as a gNB.
12. The method of any of embodiments 1-17, wherein the physical uplink control channel structure is defining a time duration (length) of the physical uplink control channel, and wherein the time duration is a defined as a number of slots or a number of symbols.
13. The method of embodiments 2-6 wherein determining (S11) a physical uplink control channel structure comprises determining the length (time duration) of the physical uplink control channel, in number of symbols or slots, based on the configured/used physical uplink control channel numerology or frequency subcarrier spacing and a physical uplink control channel configuration configured for the wireless device.
14. The method of embodiments 6-13, wherein a first physical uplink control configuration, Conf 1, relates to a longer physical uplink control channel configuration, and a second configuration, Conf 2, relates to a shorter physical uplink control channel configuration.
15. The method of any of embodiments 2-14, wherein the physical uplink control channel structure is determined based on the obtained or used numerology or frequency subcarrier spacing together with a slot configuration or slot interval (number of symbols per slot).
16. The method of embodiments 3-15, wherein the obtaining (S10) information indicating a numerology or frequency subcarrier spacing further comprises obtaining (S10a) a slot configuration or slot interval.
17. The method of embodiments 12-14, wherein a first physical uplink control channel configuration (Conf 1) is 14 symbols for a reference numerology and a second physical uplink control channel configuration (Conf 2) is 7 symbols for a reference numerology, and wherein the physical uplink control channel length, L, is determined according to:
   L=14·2\hat{ }(n−n₀), if a first physical uplink control channel configuration (Conf 1) of 14 symbols is configured or
   L=7·2\hat{ }(n−n₀), if a second physical uplink control channel configuration (Conf 2) of 7 symbols is configured
   where n is the n value for the configured/used numerology and no is the n value for the reference numerology and the length, L, is in number of symbols; or

L=N_{slot,n}=2ⁿ⁻ⁿ^{₀}⁾·N_{slot,n_0}
where L is in number of slots, N_{slot,n} is the length in number of slots for numerology n, and N_{slot,n}_{₀}, is the number slots in the reference numerology no.
18. The method of embodiments 12-16, wherein the obtaining (S10) information indicating a numerology or frequency subcarrier spacing further comprises obtaining (S10b) a physical uplink control channel time duration in milliseconds, the time duration being defined by the physical uplink control channel configuration used (e.g. Conf 1 or Conf 2), and wherein the length (time duration) of the physical uplink control channel in number of symbols or slots, is determined according to:

N_{slot,n}=T₀/T_{slot,n}
where N_{slot,n} is the length in number of slots of the physical uplink control channel for a numerology n (having n value n), T₀ is the obtained duration of the physical uplink control channel duration in milliseconds (defined by Conf 1 or Conf 2) and T_{slot,n} is the slot duration of numerology n, and

N_{symb,n}=N_{slot,n}·L=T₀/T_{slot,n}·L
Where N_{symb,n} is the length in number of symbols of the physical uplink control channel for a numerology n and L is the number of symbols in a slot interval (slot configuration).
19. The method of embodiments 12-18, wherein the symbols are OFDM symbols or SC-FDMA symbols.
20. The method of any of embodiments 1-19, wherein the physical uplink control channel configuration is a PUCCH configuration for NR.
21. A method for use in a network node in a wireless communication system for receiving a physical uplink control channel, the method comprising:
   transmitting (S1) information indicating at least one physical uplink control channel numerology or frequency subcarrier spacing configuration to at least one wireless device;
   receiving (S3), from the at least one of the wireless device, an uplink control information message on a physical uplink control channel, the physical uplink control channel structure being based on the transmitted information.
22. The method of embodiment 21 further comprising:
   obtaining (S0) information indicating one or more of numerologies or frequency subcarrier spacings that the wireless device is able to use and/or that the wireless device should use.
23. The method of embodiment 22, wherein obtaining (S0) information comprises determining at least one numerology or frequency subcarrier spacing to be used by the one or more wireless devices in the network node or receiving the at least one numerology or frequency subcarrier spacing from another node.
24. The method of embodiments 19-23, wherein the transmitted (S1) information further comprises a slot configuration.
25. The method of embodiments 19-24 further comprising:
   transmitting (S2) a message to the one or more wireless devices comprising information indicating a mapping between the numerology or frequency subcarrier spacing to a physical uplink control channel structure.
26. The method of embodiment 25, wherein the transmitted message further comprises a physical uplink control channel configuration, and the physical uplink control channel structure is based both on the numerology or frequency subcarrier spacing and the physical uplink control channel configuration.
27. The method of embodiment 25-26, wherein the transmitted message comprises a table or indicated a mapping in a table stored in the memory of the wireless device.
28. The method of embodiment 19-27, wherein the physical uplink control channel structure defines the length (time duration) of the physical uplink control channel.
29. The method of embodiments 19-28, wherein the network node is a gNB.
30. A wireless device (10), configured to operate in a wireless communication system (100), configured for transmitting a physical uplink control channel to a network node (20), the wireless device (10) comprising:
   a communication interface (11) and
   processing circuitry (12) configured to cause the wireless device (10):
      to transmit uplink control information to one or more radio nodes on a physical uplink control channel having a physical uplink control channel structure, the physical uplink control channel structure used being based on at least one numerology or frequency subcarrier spacing used by the wireless device (10) for transmitting the physical uplink control channel.
31. The wireless device (10) of embodiment 30, wherein the processing circuitry (12) is further configured to:
   obtain information indicating at least one numerology or frequency subcarrier spacing to be used by the wireless device (10); and
   determine a physical uplink control channel structure, the physical uplink control channel configuration being determined based on at least one numerology or frequency subcarrier spacing used by the wireless device (10).
32. The wireless device (10) of embodiments 30-31, wherein each numerology or frequency subcarrier spacing maps to either a first physical uplink control channel configuration or a second physical uplink control channel configuration, and wherein the processing circuitry (12) is further configured to:
   determine a first physical uplink control channel structure by mapping the numerology or frequency subcarrier spacing to a first physical uplink control channel configuration; or
   determine a second physical uplink control channel structure by mapping the numerology or frequency subcarrier spacing to a second physical uplink control channel configuration.
33. A network node (20), configured to operate in a wireless communication system (100), configured for receiving a physical uplink control channel from a wireless device (10), the network node (20) comprising:
   a communication interface (21); and
   processing circuitry (22) configured to cause the network node (20):
      to transmit information indicating at least one numerology or frequency subcarrier spacing to one or more wireless devices;
      to receive an uplink control information message on a physical uplink control channel, the structure of the physical uplink control channel being based on the transmitted information.
34. The network node (20) of embodiment 33 wherein the processing circuitry (22) is further configured to:
   obtain information indicating one or more of numerologies or frequency subcarrier spacings that the wireless device is able to use and that the more wireless device (10) should use; and
   transmit a message to the wireless device (10) comprising information indicating how to map the numerology or frequency subcarrier spacing to a physical uplink control channel structure.
35. A wireless device (10) configured to:
   obtain information indicating at least one numerology or frequency subcarrier spacing configuration to be used by the wireless device;
   determine a physical uplink control channel structure, the physical uplink control channel structure being determined based on at least one numerology or frequency subcarrier spacing used by the wireless device; and
   transmit uplink control information to one or more radio nodes on a physical uplink control channel using the determined physical uplink control channel structure.
36. The wireless device (10) of embodiment 35 configured to perform the method of any of embodiments 1-20.
37. A network node (20) configured to:
   obtain information indicating one or more of numerologies or frequency subcarrier spacings that the wireless device is able to use and that the more wireless device (10) should use;
   transmit information indicating at least one numerology or frequency subcarrier spacing to one or more wireless devices;
   transmit a message to the wireless device (10) comprising information indicating a mapping between the numerology or frequency subcarrier spacing to a physical uplink control channel structure; and
   receive an uplink control information message on a physical uplink control channel, the physical uplink control channel structure being based on the transmitted information.
38. The network node (20) of embodiment 37 configured to perform the method of any of embodiments 21-29.
39. A wireless device comprising:
   modules (41-43) operative to obtain information indicating at least one numerology or frequency subcarrier spacing configuration to be used by the wireless device, determine a physical uplink control channel structure, the physical uplink control channel structure being determined based on at least one numerology or frequency subcarrier spacing used by the wireless device, and transmit uplink control information to one or more radio nodes on a physical uplink control channel using the determined physical uplink control channel structure.
40. A network node comprising:
   modules (51-54) operative to obtain information indicating one or more of numerologies or frequency subcarrier spacings that the wireless device is able to use and that the more wireless device (10) should use, transmit information indicating at least one numerology or frequency subcarrier spacing to one or more wireless devices, transmit a message to the wireless device (10) comprising information indicating a mapping between the numerology or frequency subcarrier spacing to a physical uplink control channel structure, and receive an uplink control information message on a physical uplink control channel, the structure of the physical uplink control channel being based on the transmitted information.
41. A computer program comprising computer program code which, when executed in a wireless device, causes the wireless device to execute the methods according to any of the embodiments 1-20.
42. A computer program comprising computer program code which, when executed in a network node, causes the network node to execute the methods according to any of the embodiments 21-29.
43. A carrier containing the computer program of any of embodiments 41-42, wherein the carrier is one of an electronic signal, optical signal, radio signal, or computer readable storage medium.

1. A method for use in a wireless device in a wireless communication system for transmitting a physical uplink control channel, the method comprising:
transmitting uplink control information, UCI, to one or more radio nodes on a physical uplink control channel having a physical uplink control channel structure, the physical uplink control channel structure being based on at least one numerology configured for or used by the wireless device for transmitting the physical uplink control channel.

2. The method of claim 1 further comprising:
determining a physical uplink control channel structure, the physical uplink control channel structure being determined based on at least one numerology configured for or used by the wireless device.

3. The method of claim 1 further comprising:
obtaining information indicating at least one numerology configuration to be used by the wireless device.

4. The method of claim 3, wherein the obtained information indicating a numerology or frequency subcarrier spacing comprises receiving the information from a network node.

5. The method of claim 2, wherein each numerology or frequency subcarrier spacing maps to at least one physical uplink control channel configuration, and determining a physical uplink control channel structure comprises mapping the numerology or frequency subcarrier spacing to the at least one physical uplink control channel configuration.

6. The method of claim 5, wherein the mapping is done using a table, wherein the table defines the physical uplink control channel structure for the one or more physical uplink control channel configuration, for each configured or used numerology.

7. The method of claim 6, wherein the table defines the physical uplink control channel structure as the length in number of slots, symbols and/or samples of the physical uplink control channel for each configured or used numerology for transmitting UCI on the physical uplink control channel.

8. The method of claim 6, wherein the table is received by the wireless device, or stored in the memory of the wireless device.

9. The method of claim 8, wherein the table is stored in the memory of the wireless device and the physical uplink control channel configuration and the physical uplink control channel numerology are received by the wireless device.

10. The method of claim 1, wherein the one or more radio nodes constitutes one or more of a wireless device, a network node, a cloud node or a base station, such as a gNB.

11. The method of claim 1, wherein the physical uplink control channel structure is defining a time duration of the physical uplink control channel, and wherein the time duration is a defined number of slots or number of symbols or samples.

12. The method of claim 11, wherein the number of symbols is specified as number of normal symbols and special symbols.

13. The method of claim 2 wherein determining a physical uplink control channel structure comprises determining the length of the physical uplink control channel, in number of symbols or slots, based on the configured/used physical uplink control channel numerology and a physical uplink control channel configuration configured for the wireless device.

14. The method of claim 13 wherein the uplink control channel configuration is related to a PUCCH format.

15. The method of claim 2, wherein the physical uplink control channel structure is determined based on the obtained or used numerology together with a slot configuration or slot interval.

16. The method of claim 3, wherein the obtaining information indicating a numerology or frequency subcarrier spacing further comprises obtaining a slot configuration or slot interval.

17. The method of claim 3, wherein the obtaining information indicating a numerology or frequency subcarrier spacing comprises obtaining an uplink bandwidth part configuration associated with a numerology.

18. The method of claim 11, wherein the symbols are OFDM symbols or SC-FDMA symbols.

19. The method of claim 1, wherein the physical uplink control channel configuration is a PUCCH configuration for NR.

20. A method for use in a network node in a wireless communication system for receiving a physical uplink control channel, the method comprising:
transmitting information indicating at least one physical uplink control channel numerology configuration to at least one wireless device;
receiving, from the at least one wireless device, an UCI message on a physical uplink control channel, the physical uplink control channel having a structure being based on the transmitted information.

21. The method of claim 20 further comprising:
obtaining information indicating one or more of numerologies that the wireless device is able to use or that the wireless device should use.

22. The method of claim 21, wherein obtaining information comprises determining at least one numerology to be used by the one or more wireless or receiving the at least one numerology from another node.

23. The method of claim 20, wherein the transmitted information further comprises a slot configuration or bandwidth part configuration.

24. The method of claim 20 further comprising:
transmitting a message to the one or more wireless devices comprising information indicating a mapping between the numerology and a physical uplink control channel structure.

25. (canceled)

26. (canceled)

27. (canceled)

28. (canceled)

29. (canceled)

30. A wireless device, configured to operate in a wireless communication system, configured for transmitting a physical uplink control channel to a network node, the wireless device comprising:
a communication interface and
processing circuitry configured to cause the wireless device:
to transmit uplink control information, UCI, to one or more radio nodes on a physical uplink control channel having a physical uplink control channel structure, the physical uplink control channel structure used being based on at least one numerology configured for or used by the wireless device for transmitting the physical uplink control channel.

31. The wireless device of claim 30, wherein the processing circuitry is further configured to:
obtain information indicating at least one numerology to be used by the wireless device; and
determine a physical uplink control channel structure, the physical uplink control channel structure being determined based on at least one numerology configured for or used by the wireless device for transmitting the physical uplink control channel.

32. A network node, configured to operate in a wireless communication system, configured for receiving a physical uplink control channel from a wireless device, the network node comprising:
a communication interface; and
processing circuitry configured to cause the network node:
to transmit information indicating at least one numerology to one or more wireless devices;
to receive, from the one or more wireless devices, an uplink control information, UCI, message on a physical uplink control channel, the structure of the physical uplink control channel being based on the transmitted information.

33. The network node of claim 32 wherein the processing circuitry is further configured to:
obtain information indicating one or more of numerologies that the wireless device is able to use and that the more wireless device should use; and
transmit a message to the wireless device comprising information indicating how to map the numerology or frequency subcarrier spacing to a physical uplink control channel structure.

34. A wireless device configured to:
obtain information indicating at least one numerology to be used by the wireless device;
determine a physical uplink control channel structure, the physical uplink control channel structure being determined based on at least one numerology used by the wireless device; and
transmit uplink control information to one or more radio nodes on a physical uplink control channel using the determined physical uplink control channel structure.

35. (canceled)

36. A network node configured to:
obtain information indicating one or more of numerologies that the wireless device is able to use and that the wireless device should use;
transmit information indicating at least one numerology to one or more wireless devices;
transmit a message to the wireless device comprising information indicating a mapping between the numerology and a physical uplink control channel structure; and
receive an uplink control information message on a physical uplink control channel, the physical uplink control channel structure being based on the transmitted information.

37. (canceled)

38. (canceled)

39. (canceled)

40. (canceled)
